(19) United States
(12) Patent Application Publication
(10) Pub. No.: US 2021/0131564 A1
(43) Pub. Date: May 6, 2021

(54) SEAL DEVICE

(71) Applicant: EAGLEBURGMANN JAPAN CO., LTD., Tokyo (JP)

(72) Inventor: Ryo NAKAMURA, Tokyo (JP)

(21) Appl. No.: 17/086,262

(22) Filed: Oct. 30, 2020

(30) Foreign Application Priority Data
Nov. 6, 2019 (JP) 2019-201234

(51) Int. Cl. F16J 15/3268; F16J 9/12

(52) U.S. Cl. CPC F16J 15/3268; F16J 9/12

(57) ABSTRACT

A seal device includes a casing, a mating ring, a seal ring provided in a recessed portion formed between the casing and the mating ring; and a set ring provided with a guide portion and a rotary shaft penetration portion on a radially inner side of the guide portion, the guide portion of the set ring being inserted into an opening of the mating ring and inserted, in a pressure-wrapped state, into an opening of the seal ring by elasticity of the seal ring.

### BACKGROUND OF THE INVENTION

### Field of the Invention

The present invention relates to a seal device, and particularly relates to a seal device which can be applied to ships, boats and so forth.

### Description of the Related Art

A seal device is configured to rotatably seal a portion between a casing and a rotary shaft arranged to penetrate the casing in fluid equipment. Such a seal device is often used among various types of fluid equipment and external air, and is also utilized for, e.g., a propeller shaft extending from the inside of a ship into water.

JP 2005-214293 A (see pages 6 and 7, FIG. 1) discloses a seal device mainly including a casing connected to a stern tube in a ship body, a mating ring fixed to a bow side of the casing and having a sliding surface on a stern side, and a seal ring as an end surface seal attached and fitted onto the rotary shaft, having a sliding surface on the bow side, and formed slidable on the mating ring. Such a seal device is attached to the ship body as follows. The casing is, in a sealed state, connected to the stern tube into which the rotary shaft is inserted, and the annular seal ring having elasticity is, in a pressure-wrapped state, attached to the rotary shaft. The mating ring is utilized for attachment of the annular seal ring to the rotary shaft. The mating ring loosely fitted onto the rotary shaft contacts the seal ring, and the seal ring is pushed in from the back thereof until being housed in a recessed portion inside the casing. In a state in which the mating ring contacts the casing, the mating ring is bolted and fixed to the casing.

In this seal device, in a case where the seal ring rotates integrally with the rotary shaft, the mating ring integrated with the seal ring and the casing perpendicularly crosses the rotary shaft, and the state of sliding between the sliding surfaces is maintained, leakage of liquid for cooling and lubricating the sliding surfaces can be prevented as much as possible.

### SUMMARY OF THE INVENTION

However, at the step of assembling the above-described seal ring, the annular seal ring initially attached in the pressure-wrapped state to the rotary shaft is, by the mating ring loosely fitted onto the rotary shaft, pushed in from the back thereof until being housed in the recessed portion inside the casing. In this case, a lubricant such as grease is applied to the rotary shaft, and the annular seal ring attached in the pressure-wrapped state to the rotary shaft also moves along the rotary shaft. However, due to uneven coating with the lubricant and poor handling in movement, the seal ring is easily twisted or rolled up at a press-fitting step until being housed in the recessed portion inside the casing, and the process of moving the seal ring to a given position of the rotary shaft without tilting of the posture of the seal ring takes time and effort. This leads to a problem that assembly of the seal device is extremely complicated.

The present invention has been made in view of such a problem, and an object of the present invention is to provide a seal device facilitating positioning of a seal ring upon assembly and quickly and accurately placed on a rotary shaft.

For solving the above-described problem, a seal device according to the present invention is a seal device including: a casing; a mating ring; a seal ring provided in a recessed portion formed between the casing and the mating ring; and a set ring including a guide portion a rotary shaft penetration portion on a radially inner side of the guide portion, the guide portion of the set ring being inserted into an opening of the mating ring and inserted, in a pressure-wrapped state by elasticity of the seal ring, into an opening of the seal ring. According to the features of the present invention, in a state in which the mating ring and the seal ring are held on an outer peripheral side of the guide portion of the set ring, the guide portion can move with the rotary shaft penetration portion being inserted into the rotary shaft. Thus, the force of friction with the rotary shaft is not directly applied to the seal ring, and only by detachment of the set ring performed at a predetermined position at which the casing is attached to fluid equipment such that the seal ring and the mating ring remain, the seal ring is brought into the pressure-wrapped state on the rotary shaft by elastic force of the seal ring itself and is positioned at a proper position.

It may be preferable that the guide portion of the set ring has a stopper configured to prevent detachment of the mating ring. According to this preferable configuration, the guide portion of the set ring and the mating ring can be integrally moved, and workability is improved.

It may be preferable that the guide portion of the set ring is inserted into the mating ring in a tightened state. According to this preferable configuration, the inner diameter center of the set ring and the inner diameter center of the mating ring are aligned with each other, and therefore, the inner diameter center of the mating ring and the diameter center of the rotary shaft can be aligned with each other. Thus, centering adjustment for the mating ring is not necessary, and the time for assembling the seal device can be shortened.

It may be preferable that the guide portion of the set ring has a first annular plate part brought into contact with an inner peripheral surface of the seal ring and formed continuously in a circumferential direction. According to this preferable configuration, the strength of the first annular plate part is held, and therefore, the set ring can be reliably fitted in the seal ring.

It may be preferable that the guide portion of the set ring has a second annular plate part inserted into the mating ring, and the second annular plate part is thicker than the first annular plate part. According to this preferable configuration, a separation distance between the mating ring and the rotary shaft can be increased, and contact of the mating ring with the rotary shaft upon operation can be prevented. Further, the first annular plate part is relatively thin, and a difference in pressure-wrapping force of the seal ring in a state in which the set ring is pressure-wrapped around the seal ring is small. Thus, the set ring is easily pulled out of the seal ring. In addition, the second annular plate part is relatively thick, and therefore, the strength of the set ring itself is increased.

It may be preferable that the set ring is provided with a pull portion for pulling the set ring in an axial direction departing from the casing. According to this preferable configuration, the set ring can be easily pulled out of the seal ring in a state in which the set ring is fitted onto the rotary shaft with the set ring penetrating the mating ring and being fitted in the seal ring.

It may be preferable that the mating ring is fastened to the casing by fastening means, and the casing, the mating ring, the seal ring, and the set ring are be unitized. According to this preferable configuration, the seal device including the casing in advance can be unitized, and therefore, assembly of the seal device can be facilitated.

It may be preferable that at least one split line extending in an axial direction is be formed at the set ring. According to this preferable configuration, the set ring is split in a C-shape or divided into multiple portions. Thus, in a state in which the set ring is fitted onto the rotary shaft with the set ring penetrating the mating ring and being fitted in the seal ring, the seal ring can be detached from the rotary shaft in an outer diameter direction after having slid in the mating ring direction, and therefore, detachment of the set ring is facilitated.

### BRIEF DESCRIPTION OF THE DRAWINGS

FIG. 1 is a sectional view illustrating a seal device in a unit state, according to an embodiment of the present invention.

FIGS. 2A and 2B are sectional views illustrating the course of unitization of the seal device shown in FIG. 1.

FIGS. 3A and 3B are sectional views illustrating, subsequently to FIGS. 2A and 2B, the course of unitization of the seal device shown in FIG. 1.

FIG. 4 is a sectional view illustrating a state in which a joint hose is attached to the seal device in the unit state shown FIG. 1.

FIGS. 5A to 5C are sectional views illustrating the course of assembly of the seal device shown in FIG. 1.

FIGS. 6A to 6C are sectional views illustrating a seal ring shown in FIG. 1 when a set ring is detached.

FIG. 7A is a perspective view of the set ring in the embodiment, and FIGS. 7B and 7C are perspective views of a set ring in a first variation of the embodiment.

FIGS. 8A to 8C are perspective views of a set ring in a second variation of the embodiment.

### DETAILED DESCRIPTION

Hereinafter, modes for carrying out a seal device according to the present invention will be described based on an embodiment.

### Embodiment

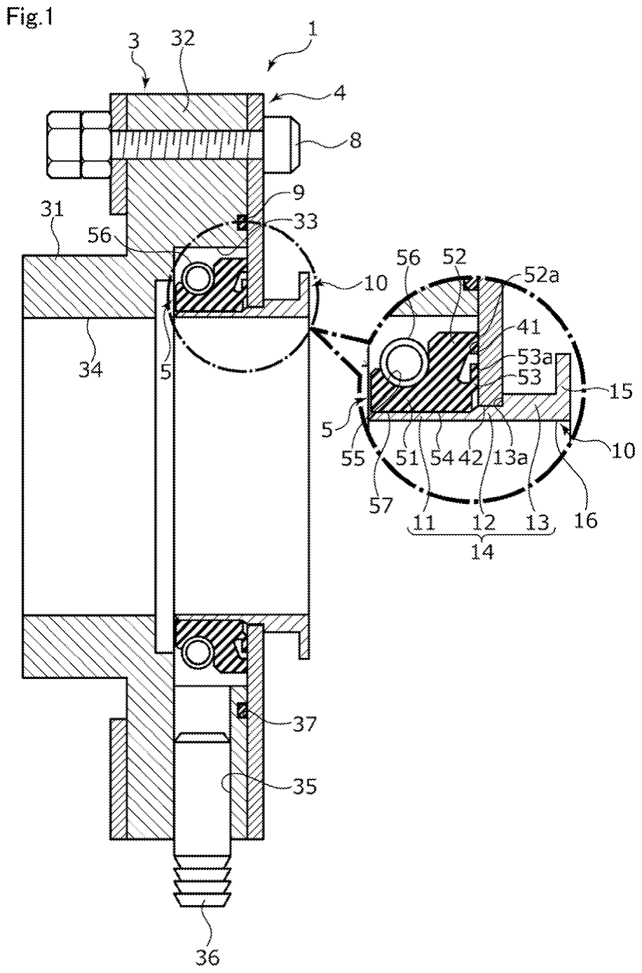

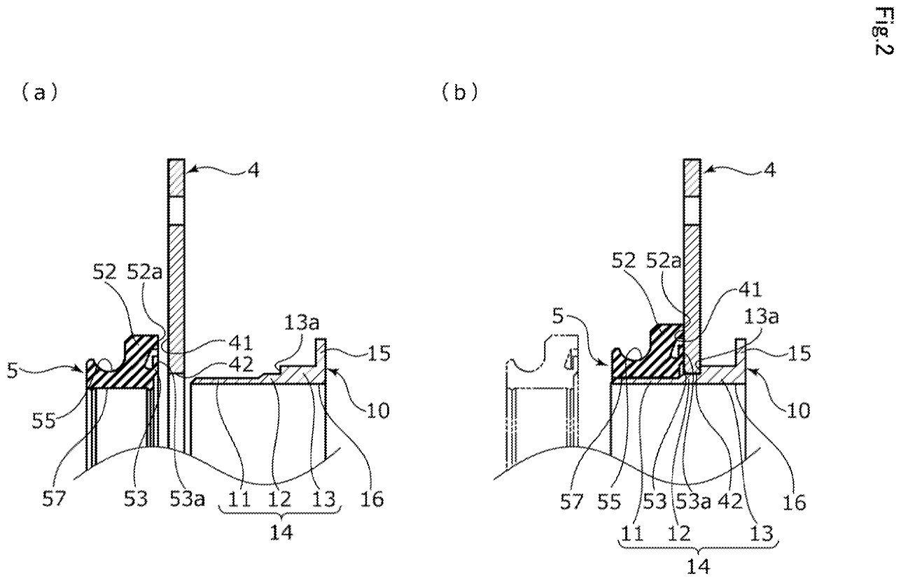

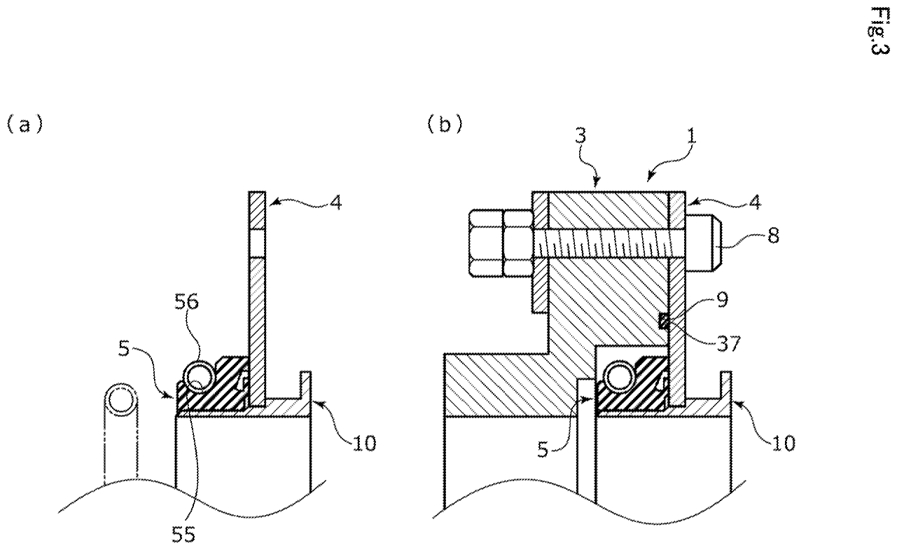

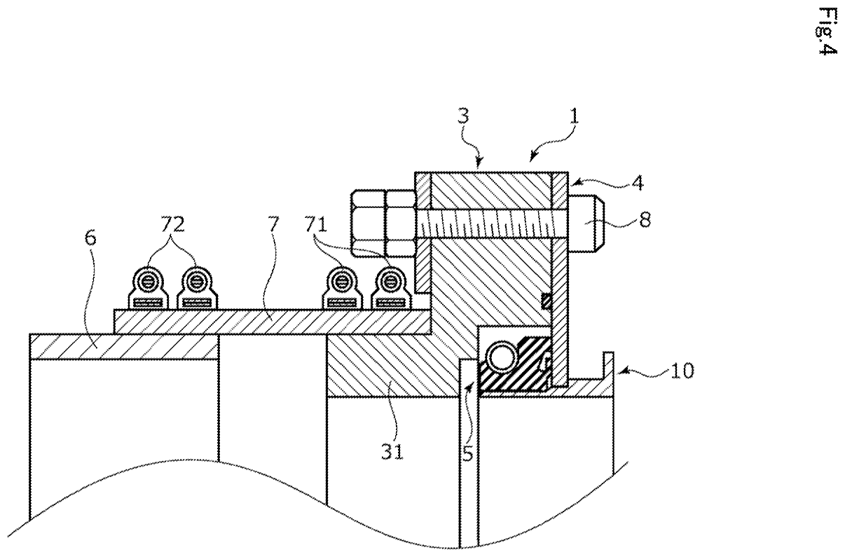

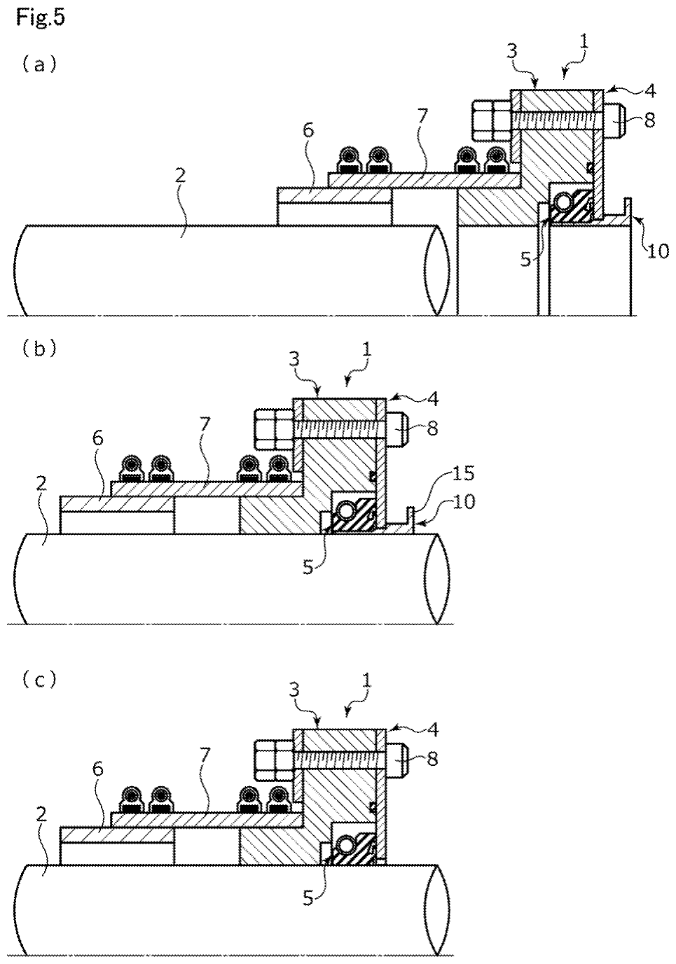

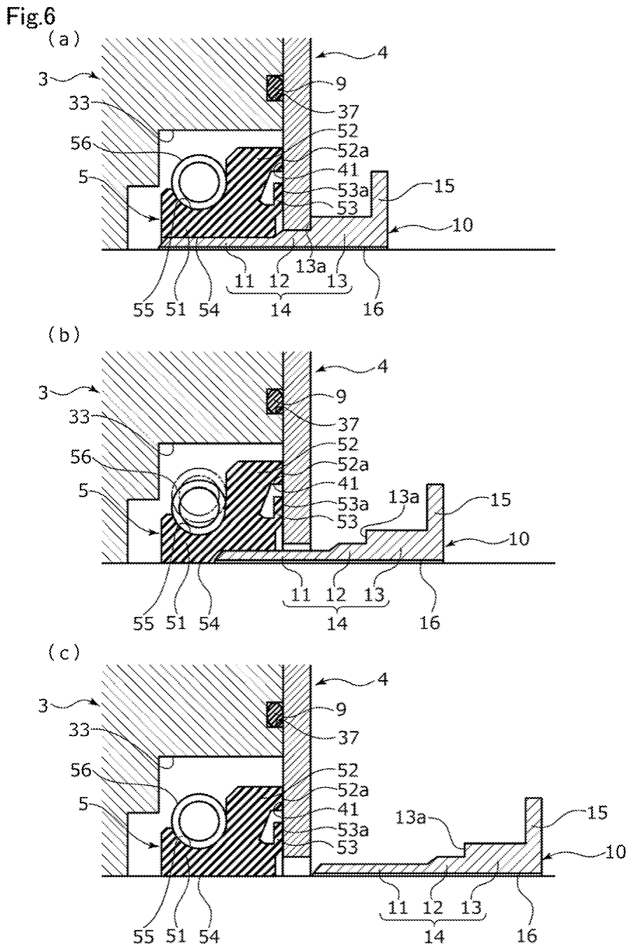

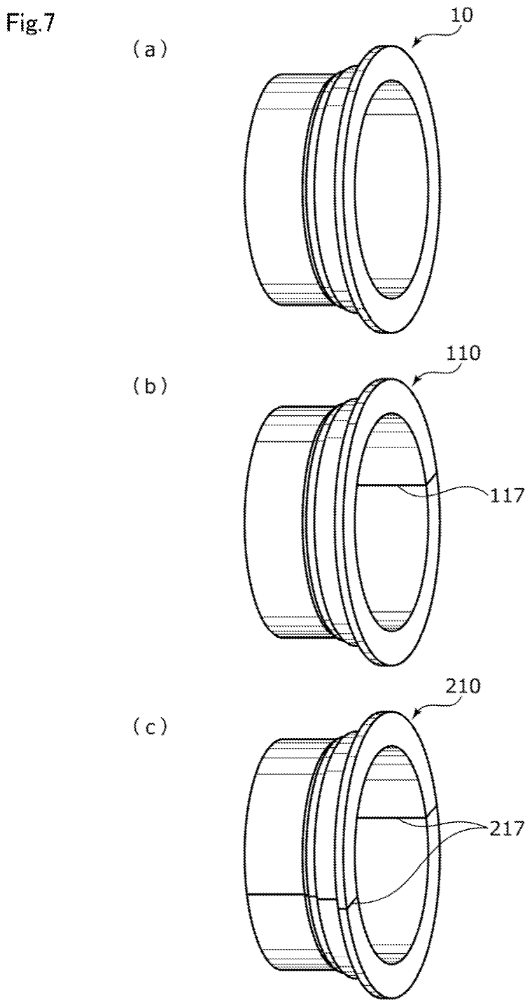

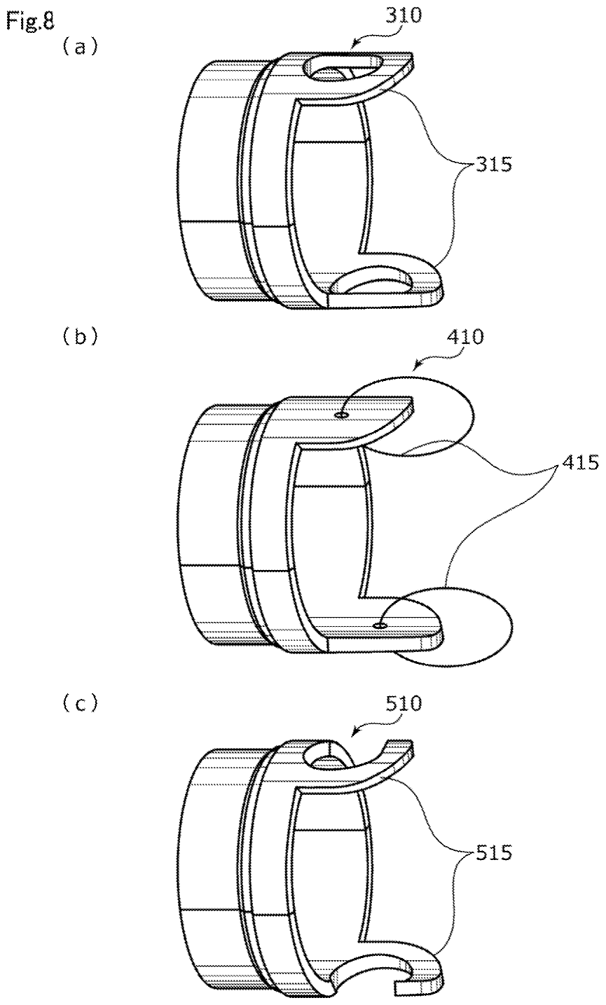

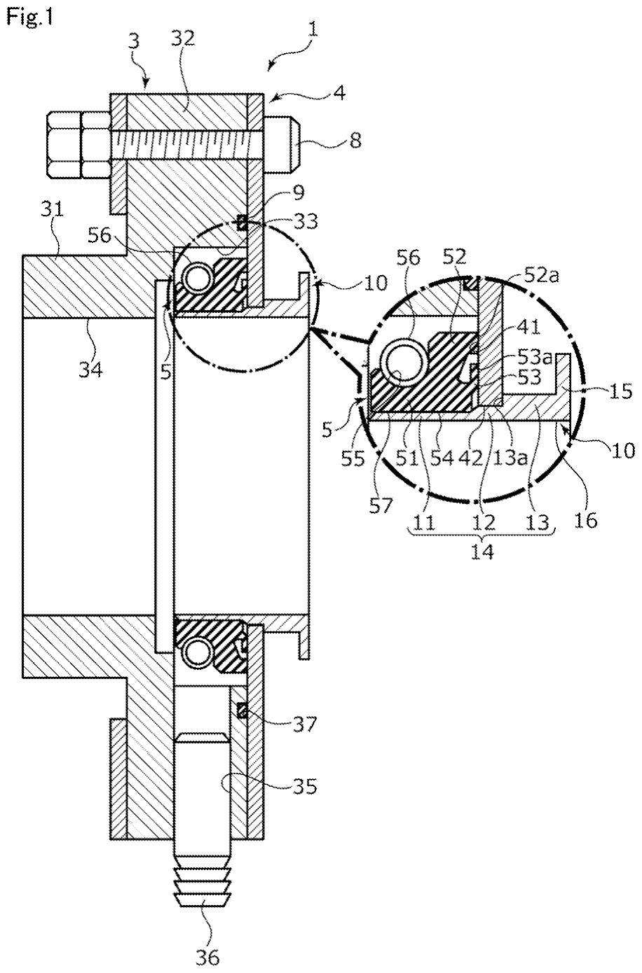

A seal device according to an embodiment will be described with reference to FIGS. 1 to 8. Hereinafter, in the present embodiment, a left side in the plane of paper of FIG. 1 will be described as a stern side or a casing side, and a right side in the plane of paper will be described as a bow side or a mating side.

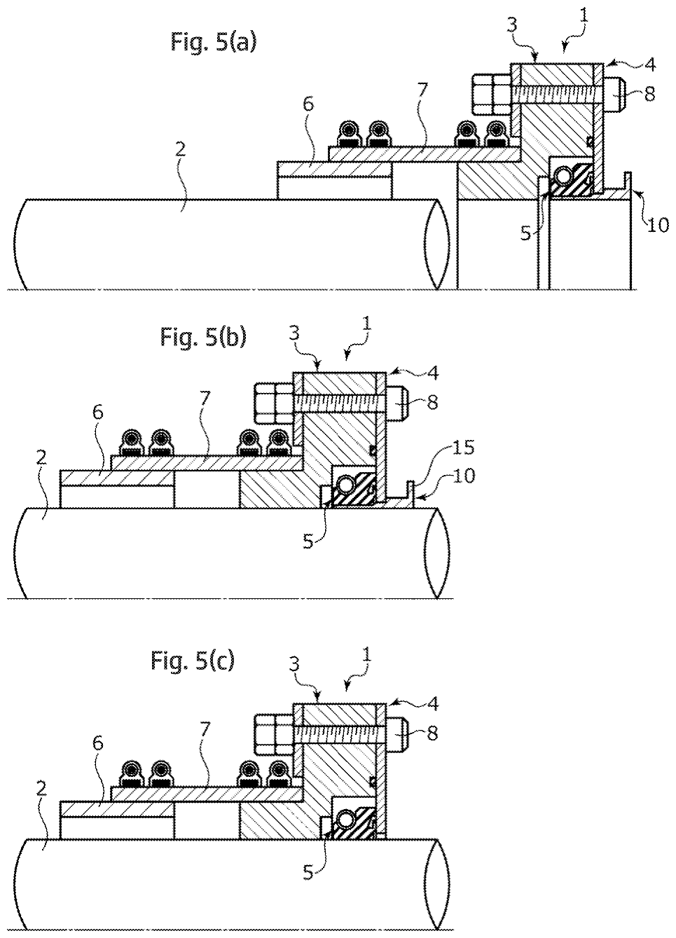

A seal device 1 is applied to a stern tube as cylindrical fluid equipment through which a rotary shaft 2 connecting a propeller and a motor of a ship penetrates. As illustrated in FIG. 1, the seal device 1 includes a casing 3, a mating ring 4 fixed to a bow-side side end of the casing 3, a seal ring 5 fitted onto the rotary shaft 2 upon use, and a set ring 10 (see FIG. 5A) detachably fitted in the mating ring 4 and the seal ring 5. The casing 3, the mating ring 4, the seal ring 5, and the set ring 10 can be temporarily unitized by the set ring 10. Note that the fluid equipment is not limited to one used for the ship, but may be fluid equipment used for, e.g., an automobile or a general industrial machine.

The casing 3 has a cylindrical portion 31 and a flange portion 32 extending in an outer diameter direction from the bow side of the cylindrical portion 31, and a recessed portion 33 recessed from a bow-side end portion to the stern side is formed on an inner diameter side of the flange portion 32. Moreover, a sliding surface 34 of the cylindrical portion 31 can slide on the rotary shaft 2 after assembly (see FIG. 5C). The casing 3 is made of a resin material for a bearing with favorable lubricity. For example, epoxy resin (ER), polyimide resin (PI), polyetheretherketone (PEEK), or a composite resin material of these resins and reinforcement fibers may be used, and as other materials, hard rubber, aluminum, copper alloy, an oil-containing sintered bearing, etc. may be utilized. Note that the inner diameter of the casing 3 may be greater than the outer diameter of the rotary shaft 2, and an inner peripheral surface of the cylindrical portion 31 does not necessarily slide on the rotary shaft 2 after assembly.

At the flange portion 32 of the casing 3, a communication path 35 formed to extend to an outer diameter side from the recessed portion 33 is connected to the outside of the casing 3 through connection means 36. Coolant water is, after assembly, supplied from the outside of the casing 3 to the recessed portion 33 through the communication path 35. The coolant water can cool the rotary shaft 2 and the sliding surface 34 and the mating ring 4 and the seal ring 5 in a sliding relationship in operation, and can smoothly lubricate portions among these sliding surfaces (see FIG. 1).

The mating ring 4 is made of a metal or resin material, and is in a thin discoid plate shape formed with an opening 42 at the center. Moreover, the mating ring 4 is, in a state in which the outer diameter side thereof contacts a bow-side end surface of the casing 3, fastened to the casing 3 with bolt nuts 8 as fastening means at multiple locations at equal intervals across a circumferential direction (FIG. 1 only illustrates one location), and an inner-diameter-side stern-side surface of the mating ring 4 is a sliding surface 41. Moreover, an O-ring 9 is fitted in a ring groove 37 formed across the circumferential direction at the bow-side end surface of the casing 3. The mating ring 4 is bolted to the casing 3 with the bolt nuts 8 so that the casing 3 and the mating ring 4 can be sealed. Note that the mating ring 4 is not limited to one fastened to the casing 3 with the bolt nuts 8, and for example, may be fastened by welding fixing.

The seal ring 5 is made of a rubber or resin material having elasticity, and has a slightly smaller inner diameter than the outer diameter of the rotary shaft 2. The seal ring 5 has a base portion 51 and two protrusions of lip portions 52, 53 extending from the base portion 51 to the bow side. Bow-side end surfaces of these two protrusions of the lip portions 52, 53 are sliding surfaces 52a, 53a, and a contact surface 54 as an inner peripheral surface contactable with the rotary shaft 2 is formed at the inner periphery of the base portion 51. A garter spring 56 is fitted onto a back groove 55 formed on the outer diameter side of the seal ring 5 and having a U-shaped section, and improves pressure-wrapping force of the seal ring 5 fitted and attached onto the rotary shaft 2. After assembly, the recessed portion 33 of the casing 3 housing the seal ring 5 is filled with the coolant water, and the water pressure of the coolant water is added to improve the pressure-wrapping force of the seal ring 5. Note that the lip portions 52, 53 are not limited to two annular protrusions, and may be one annular protrusion or three or more annular protrusions. Note that fastening with other types of tightening means such as a zip tie may be employed instead of fitting the garter spring 56 onto the back groove 55, and the tightening means such as the garter spring 56 is not essential.

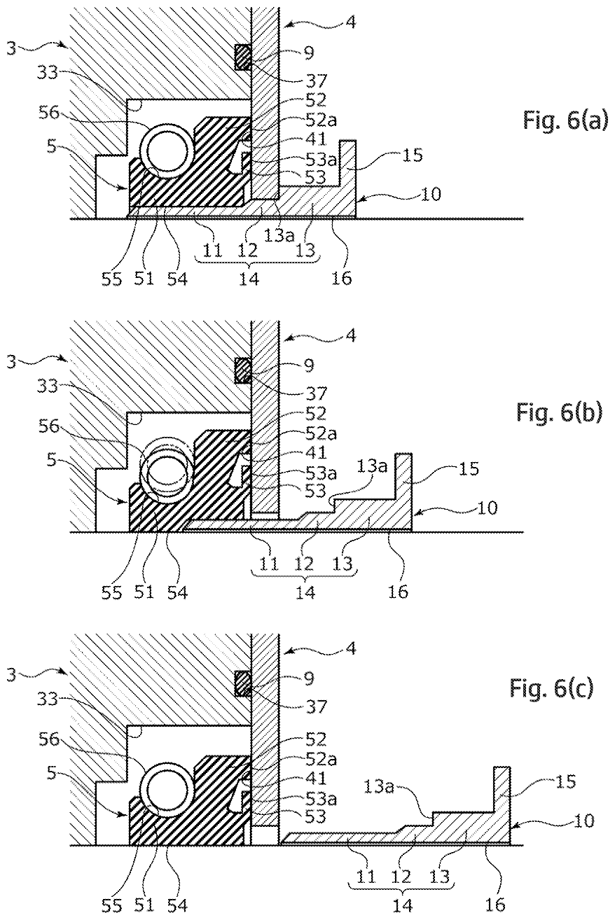

The set ring 10 is made of metal or resin, and has a thin guide portion 14 and a flange portion 15 as a pull portion extending in the outer diameter direction from a bow-side end portion of the guide portion 14. A rotary shaft penetration portion 16 extending in an axial direction in parallel with an inner portion of the guide portion 14 is formed at the set ring 10. The guide portion 14 includes, from the stern side to the bow side, a first annular plate part 11, a second annular plate part 12 thicker than the first annular plate part 11, and a third annular plate part 13 thicker than the second annular plate part 12. The first annular plate part 11, the second annular plate part 12, and the third annular plate part 13 form a step shape as viewed in section, and a stern-side side surface of the third annular plate part 13 is a stopper 13a contactable with the mating ring 4. Moreover, stern-side corners of the first annular plate part 11 and the second annular plate part 12 are chamfered so that the set ring 10 can be smoothly fitted in the mating ring 4 and the seal ring 5. Further, the inner diameter of the set ring 10 is slightly greater than the outer diameter of the rotary shaft 2, and therefore, the set ring 10 can be fitted onto the rotary shaft 2 (see FIG. 6A). Note that the first annular plate part 11 is not limited to one formed continuously in the circumferential direction, and for example, may be formed in a comb shape across the circumferential direction such that each tooth of the comb shape extends in the axial direction. Note that the inner diameter of the set ring 10 may be the same as the outer diameter of the rotary shaft 2.

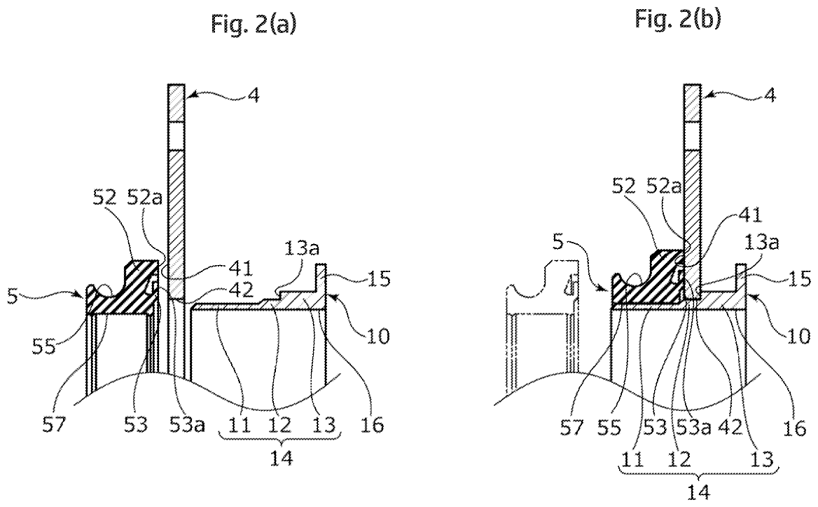

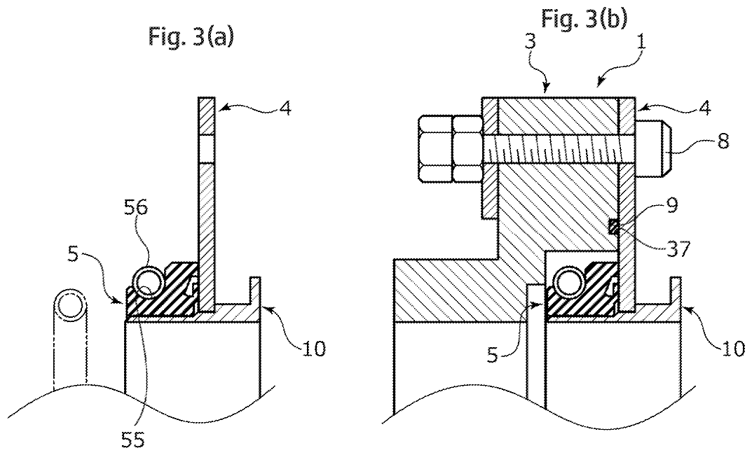

Unitization of the seal device 1 will be described with reference to FIGS. 2A, 2B, 3A, and 3B. First, after not-shown grease has been applied to outer surfaces of the first annular plate part 11 and the second annular plate part 12 of the guide portion 14 of the set ring 10 and extra grease has been removed, it is checked whether or not the grease adheres to the sliding surface 41 of the mating ring 4, and degreasing is performed as necessary. Thereafter, as illustrated in FIGS. 2A and 2B, the guide portion 14 of the set ring 10 is inserted into the opening 42 of the mating ring 4 from the bow side, and is pushed in until the stopper 13a of the third annular plate part 13 contacts the mating ring 4. The second annular plate part 12 and the mating ring 4 have the substantially same dimension in the axial direction, and the outer diameter of the second annular plate part 12 and the inner diameter of the mating ring 4 are the substantially same as each other. Thus, the second annular plate part 12 is, without any clearances, fitted in the mating ring 4 across the axial direction. Note that application of the grease and removal of the excess may be performed only for the outer surface of the first annular plate part 11.

Subsequently, it is checked whether or not the grease adheres to the sliding surfaces 52a, 53a of the lip portions 52, 53 of the seal ring 5, and degreasing is performed as necessary. Thereafter, as illustrated in FIG. 2B, the guide portion 14 of the set ring 10 is inserted into an opening 57 from the bow side while the diameter of the seal ring 5 is being expanded, and is pushed in until the seal ring 5 contacts the mating ring 4. In this manner, the mating ring 4 is sandwiched between the seal ring 5 and the stopper 13a of the third annular plate part 13 of the set ring 10, and these components are integrated. At this point, due to grease lubrication action, the set ring 10 can be smoothly inserted into the opening 57 of the seal ring 5. Moreover, the first annular plate part 11 and the seal ring 5 have the substantially same dimension in the axial direction, and therefore, the first annular plate part 11 is inserted into the seal ring 5 across the axial direction.

Subsequently, as illustrated in FIG. 3A, after the grease has been applied to the back groove 55 of the seal ring 5, the garter spring 56 is expanded and fitted onto the back groove 55. Thereafter, after the O-ring 9 to which the grease had been applied has been housed in the ring groove 37 of the casing 3, the casing 3 and the mating ring 4 are fastened with the bolt nuts 8 as illustrated in FIG. 3B. The seal device 1 can maintain a unit state without separation as described above, and therefore, the seal device 1 can be transported unit by unit. Moreover, the mating ring 4 is integrated with the seal ring 5 and the stopper 13a of the third annular plate part 13 of the set ring 10 by being sandwiched between the seal ring 5 and the stopper 13a of the third annular plate part 13 of the set ring 10, and therefore, a state in which the sliding surface 41 of the mating ring 4 and the sliding surfaces 52a, 53a of the lip portions 52, 53 of the seal ring 5 contact each other can be maintained.

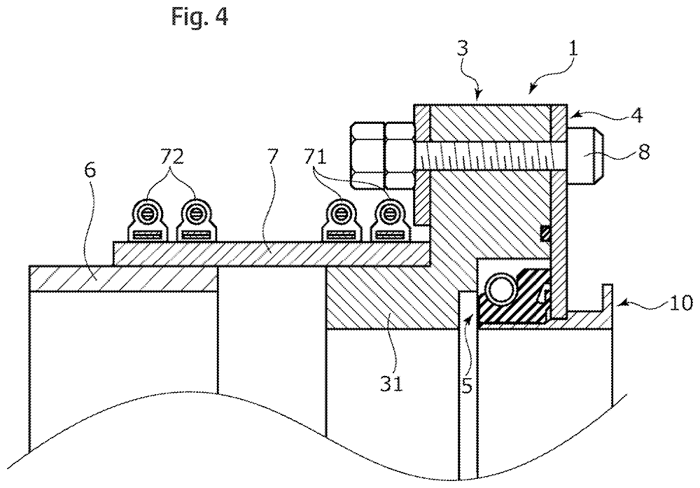

As illustrated in FIG. 4, a joint hose 6 is attached to the stern side of the casing 3 of the unitized seal device 1 so that the casing 3 can be connected to the stern tube. Specifically, a cylindrical rubber tube 7 is fitted onto the cylindrical portion 31 of the casing 3 and the joint hose 6, and two fastening bands 71 and two fastening bands 72 are further pressure-wrapped around the cylindrical portion 31 and the joint hose 6. In this manner, the casing 3 and the joint hose 6 are coupled to each other. Note that two bands are not necessarily provided as each of the fastening bands 71, 72, and pressure-wrapping means is not limited to those described above. Note that attachment of the joint hose 6 may be performed right before the mating ring 4 is bolt-fastened to the casing 3, and in this case, the joint hose 6 may be taken as part of the unit.

Subsequently, assembly of the seal device 1 in the unit state will be described. As illustrated in FIG. 5A, the seal device 1 in the unit state is fitted onto the rotary shaft 2 from the bow side, and the joint hose 6 is connected to the not-shown stern tube fitted onto the rotary shaft 2 in advance and arranged on a stern tube side. Thus, the casing 3 is connected to the stern tube through the joint hose 6 and the rubber tube 7, and therefore, the seal device 1 is fixed to the rotary shaft 2 at a predetermined position in the axial direction (see FIG. 5B). At this point, the pressure-wrapping force of the seal ring 5 and the garter spring 56 is received by the set ring 10, and is not applied to the rotary shaft 2. Thus, the set ring 10 can easily move on the rotary shaft 2.

Thereafter, the set ring 10 fitted onto the rotary shaft 2 with the set ring 10 being fitted in the mating ring 4 and the seal ring 5 is pulled toward the bow side and detached with the flange portion 15 of the set ring 10 being gripped (see FIG. 5C). At this point, the seal ring 5 is, following the set ring 10, pressed against the mating ring 4 while the diameter of the seal ring 5 is narrowed (see FIGS. 6A and 6B). Thus, while maintaining the state of contact with the sliding surface 41 of the mating ring 4, the sliding surfaces 52a, 53a of the lip portions 52, 53 of the seal ring 5 are pressure-wrapped at proper positions on the rotary shaft 2 (see FIG. 6C). Note that the inner diameter of the set ring 10 is slightly greater than the outer diameter of the rotary shaft 2, and the guide portion 14 can move in the axial direction with the rotary shaft penetration portion 16 being inserted into the rotary shaft 2. Thus, the set ring 10 can be smoothly detached. Note that the not-shown grease is applied to the first annular plate part 11 of the set ring 10, and therefore, the seal ring 5 can be smoothly detached from the set ring 10.

Moreover, in the unit state, the mating ring 4 is sandwiched between the seal ring 5 and the stopper 13a of the third annular plate part 13 of the set ring 10. Thus, after the set ring 10 has been pulled out, the seal ring 5 is fitted onto the rotary shaft 2 while maintaining the state of contact with the mating ring 4. Thus, the trouble of adjusting the degree of contact between the mating ring 4 and the seal ring 5 is avoided, and assembly is facilitated.

Further, the seal ring 5 is fitted onto the rotary shaft 2 while part of the grease remains on the contact surface 54. Thus, even if the rotary shaft 2 displaces in the axial direction during operation, the seal ring 5 is less movable in the axial direction together with the rotary shaft 2. Thus, the state of sliding between the mating ring 4 and the seal ring 5 can be maintained.

In addition, for the sliding surface 41 of the mating ring 4 and the sliding surfaces 52a, 53a of the lip portions 52, 53 of the seal ring 5, it is confirmed that these portions are in a degreased state upon unitization of the seal device 1. Such a degreased state is maintained after assembly. Thus, damage of the sliding surfaces can be prevented. Further, a degreasing process in a limited space upon assembly can be omitted, and an assembly process can be simplified.

Moreover, application of the grease and removal of the excess are performed in advance upon unitization of the seal device 1. Thus, the process of applying the grease and removing the excess in the limited space upon assembly can be omitted, and the assembly process can be simplified. Further, an operational error such as adherence of the grease to other types of equipment can be prevented.

Further, the O-ring 9 is fitted in the ring groove 37 of the casing 3 upon unitization of the seal device 1. Thus, the process of fitting the O-ring 9 in the ring groove 37 in the limited space upon assembly can be omitted, and the assembly process can be simplified.

In addition, the present invention can be also applied to a case where the seal device 1 is not unitized during transport, and in this case, the seal device 1 is unitized right before assembly so that assembly can be facilitated.

As described above, the set ring 10 having the thin guide portion 14 inserted into the opening of the mating ring 4 and the opening of the seal ring 5 and including the rotary shaft penetration portion 16 at the inner portion of the guide portion 14, the mating ring 4, and the seal ring 5 are provided. The guide portion 14 of the set ring 10 is inserted into the opening of the mating ring 4, and in a pressure-wrapped state, is inserted into the opening of the seal ring 5 by the elasticity of the seal ring 5. Thus, the guide portion 14 of the set ring 10 can move with the rotary shaft penetration portion 16 being inserted into the rotary shaft 2 in a state in which the mating ring 4 and the seal ring 5 are held on an outer peripheral side of the guide portion 14 of the set ring 10. Thus, the force of friction with the rotary shaft 2 is not directly applied to the seal ring 5, and only by detachment of the set ring 10 performed at a predetermined position at which the casing 3 is attached to the stern tube such that the seal ring 5 and the mating ring 4 remain, the seal ring 5 is brought into the pressure-wrapped state on the rotary shaft 2 by the elastic force of the seal ring 5 itself and is positioned at a proper position.

Moreover, the guide portion 14 of the set ring 10 has the stopper 13a preventing detachment of the mating ring 4. Thus, the guide portion 14 of the set ring 10 and the mating ring 4 can be integrally moved, and workability is improved.

Further, the guide portion 14 of the set ring 10 can be tightened with the mating ring 4, and the center of the inner diameter of the mating ring 4 and the diameter center of the rotary shaft 2 can be aligned with each other. Thus, centering adjustment for the mating ring 4 is not necessary, and the time for assembling the seal device 1 can be shortened.

In addition, the guide portion 14 of the set ring 10 has the first annular plate part 11 formed contactable with the contact surface 54 of the seal ring 5 and formed continuously in the circumferential direction. Thus, the strength of the first annular plate part 11 can be held, and the set ring 10 can be reliably fitted in the seal ring 5.

Moreover, the guide portion 14 of the set ring 10 has the second annular plate part 12 inserted into the mating ring 4, and the second annular plate part 12 is thicker than the first annular plate part 11. Thus, a separation distance between the mating ring 4 and the rotary shaft 2 can be increased, and contact of the mating ring 4 with the rotary shaft 2 upon operation can be prevented. Further, the first annular plate part 11 is relatively thin, and a difference in the pressure-wrapping force of the seal ring 5 in a state in which the set ring 10 is pressure-wrapped around the seal ring 5 is small. Thus, the set ring 10 can be easily pulled out of the seal ring 5. In addition, the second annular plate part 12 is relatively thick, and therefore, the strength of the set ring 10 itself is increased.

Moreover, the set ring 10 has the flange portion 15 for pulling the set ring 10 to the bow side, and therefore, is easily pulled out from the seal ring 5 in a state in which the set ring 10 is fitted onto the rotary shaft 2 with the set ring 10 penetrating the mating ring 4 and being fitted in the seal ring 5.

Further, the casing 3, the mating ring 4 fastened to the casing 3 with the bolt nuts 8, the seal ring 5, and the set ring 10 are unitized. Thus, the seal device 1 including the casing 3 in advance can be unitized, and assembly of the seal device 1 can be facilitated.

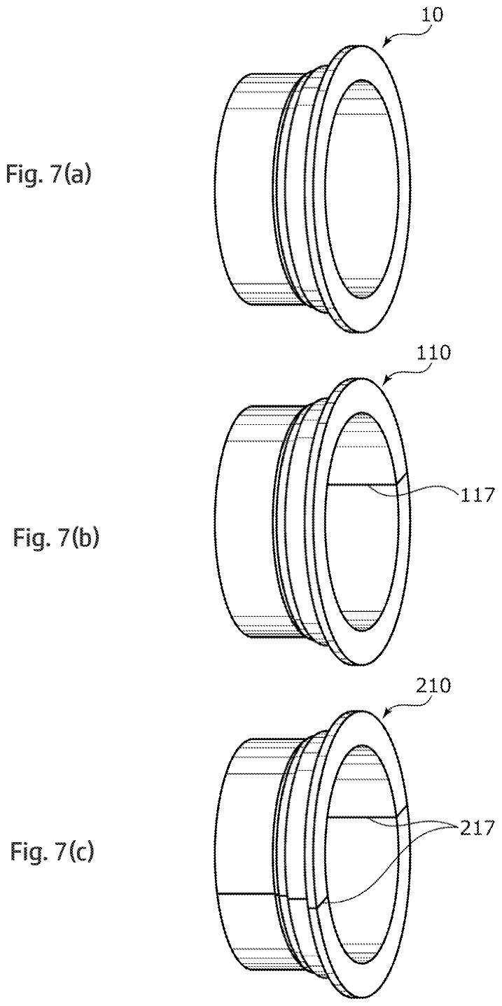

A first variation of the embodiment will be described. Note that the same reference numerals are used to represent the same components as those described above in the embodiment, and overlapping description will be omitted. In the present embodiment, the set ring 10 without any split lines as illustrated in FIG. 7A has been described. However, as illustrated in FIGS. 7B and 7C, one or two split lines 117, 217 extending in the axial direction may be formed at a set ring 110, 210. With this configuration, the set ring 110 can be split in a C-shape, and the set ring 210 can be divided into two portions. Thus, after having been pulled to the bow side upon assembly of the seal device 1, the set ring 110, 210 can be detached from the rotary shaft 2 in the outer diameter direction. Thus, detachment of the set ring 110, 210 is facilitated. Note that the number of split lines may be three or more.

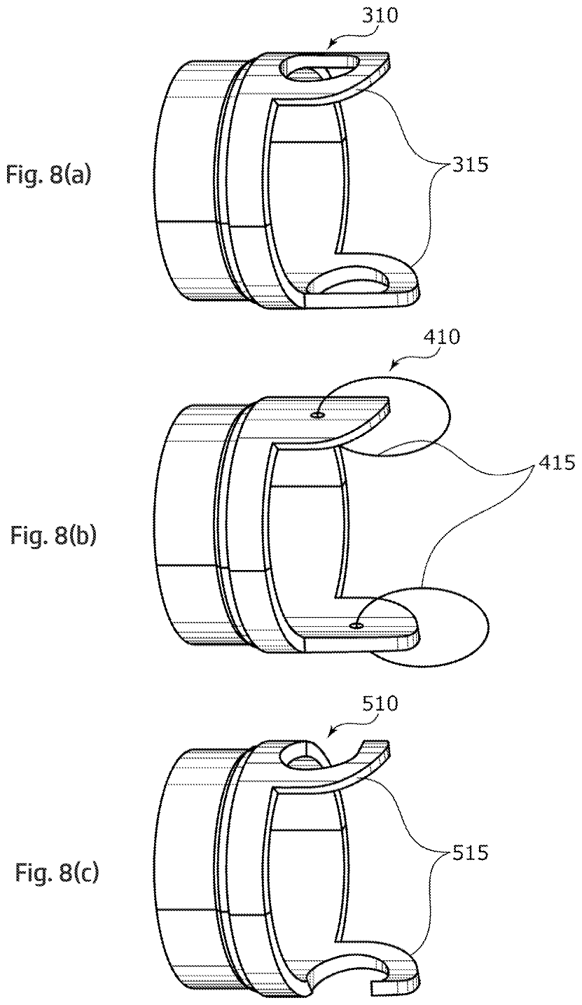

A second variation of the embodiment will be described. Note that the same reference numerals are used to represent the same components as those described above in the embodiment, and overlapping description will be omitted. In the present embodiment, the set ring 10 having the flange portion 15 on the bow side as illustrated in FIG. 7A has been described. However, the pull portion may be in a shape other than the flange shape. For example, as in FIG. 8A, circular ring pull portions 315 may be employed as pull portions extending from a third annular plate part 13 of a set ring 310 to the bow side at optional two locations. As in FIG. 8B, annular strings 415 may be employed as pull portions inserted into holes formed at extension pieces extending from a third annular plate part 13 of a set ring 410 to the bow side at optional two locations. As in FIG. 8C, C-shaped pull portions 515 may be employed as pull portions extending from a third annular plate part 13 of a set ring 510 to the bow side at optional two locations.

These set rings 310, 410, 510 have a structure extending from the third annular plate part 13 to the bow side, and therefore, are thin in a radial direction. Thus, a space for the assembly process can be easily ensured. Note that it has been described that each set ring has two pull portions, but the present invention is not limited to above. Each set ring may have one or three or more pull portions. Note that two split lines are formed in FIGS. 7A to 7C, but one or three or more split lines may be formed or the split lines are not necessarily formed.

The embodiment of the present invention has been described above with reference to the drawings, but specific configurations are not limited to these embodiments. The present invention includes changes and additions made without departing from the scope of the present invention.

For example, it has been described that the seal device 1 includes the joint hose 6, but the present invention is not limited to above. The casing 3 may be directly or indirectly connected to the stern tube without the joint hose 6.

Moreover, the sliding surface 41 of the mating ring 4 and the sliding surfaces 52a, 53a of two annular protrusions of the lip portions 52, 53 of the seal ring 5 may form flat surfaces or surfaces with recessed portions.

Further, it has been described that the stern-side corners of the first annular plate part 11 and the second annular plate part 12 are chamfered, but the present invention is not limited to above. These corners are not necessarily chamfered.

In addition, it has been described that the first annular plate part 11 and the seal ring 5 have the substantially same dimension in the axial direction, but the present invention is not limited to above. The dimension of the first annular plate part 11 in the axial direction may be relatively longer or shorter.

Moreover, it has been described that the second annular plate part 12 is thicker than the first annular plate part 11 and the outer diameter of the second annular plate part 12 and the inner diameter of the mating ring 4 are the substantially same as each other. However, the present invention is not limited to above, and the second annular plate part 12 may have the substantially same thickness as that of the first annular plate part 11 or the outer diameter of the second annular plate part 12 may be smaller than the inner diameter of the mating ring 4.

Further, the flange portion 15, the circular ring pull portion 315, the annular string 415, and the C-shaped pull portion 515 have been described as examples of the pull portion of the set ring, but the pull portion is not an essential member.

### REFERENCE SIGNS LIST

1 Seal device
2 Rotary shaft
3 Casing
4 Mating ring
5 Seal ring
8 Bolt nut (fastening means)
10 Set ring
11 First annular plate part
12 Second annular plate part
13 Third annular plate part
13a Stopper
14 Guide portion
15 Flange portion (pull portion)
16 Rotary shaft penetration portion
33 Recessed portion
42 Opening
54 Contact surface (inner peripheral surface)
57 Opening
110 Set ring
117 Split line
210 Set ring
217 Split line
310 Set ring
315 Circular ring pull portion (pull portion)
410 Set ring
415 Annular string (pull portion)
510 Set ring
515 C-shaped pull portion (pull portion)

What is claimed is:

1. A seal device comprising:
a casing;
a mating ring;
a seal ring provided in a recessed portion formed between the casing and the mating ring; and
a set ring including a guide portion a rotary shaft penetration portion on a radially inner side of the guide portion,
the guide portion of the set ring being inserted into an opening of the mating ring and inserted, in a pressure-wrapped state by elasticity of the seal ring, into an opening of the seal ring.

2. The seal device according to claim 1, wherein
the guide portion of the set ring has a stopper configured to prevent detachment of the mating ring.

3. The seal device according to claim 1, wherein
the guide portion of the set ring is inserted into the mating ring in a tightened state.

4. The seal device according to claim 1, wherein
the guide portion of the set ring has a first annular plate part brought into contact with an inner peripheral surface of the seal ring and formed continuously in a circumferential direction.

5. The seal device according to claim 4, wherein
the guide portion of the set ring has a second annular plate part inserted into the mating ring, and
the second annular plate part is thicker than the first annular plate part.

6. The seal device according to claim 1, wherein
the set ring is provided with a pull portion for pulling the set ring in an axial direction departing from the casing.

7. The seal device according to claim 1, wherein
the mating ring is fastened to the casing by a mechanical fastner, and
the casing, the mating ring, the seal ring, and the set ring are unitized.

8. The seal device according to claim 1, wherein
at least one split line extending in an axial direction are formed at the set ring.

9. The seal device according to claim 2, wherein
the guide portion of the set ring is inserted into the mating ring in a tightened state.

10. The seal device according to claim 2, wherein
the guide portion of the set ring has a first annular plate part brought into contact with an inner peripheral surface of the seal ring and formed continuously in a circumferential direction
the guide portion of the set ring further has a second annular plate part inserted into the mating ring, and
the second annular plate part is thicker than the first annular plate part.

11. The seal device according to claim 2, wherein
the set ring is provided with a pull portion for pulling the set ring in an axial direction departing from the casing.

12. The seal device according to claim 2, wherein
the mating ring is fastened to the casing by a mechanical fastener, and
the casing, the mating ring, the seal ring, and the set ring are unitized.

13. The seal device according to claim 2, wherein
at least one split line extending in an axial direction are formed at the set ring.

14. The seal device according to claim 3, wherein
the guide portion of the set ring has a first annular plate part brought into contact with an inner peripheral surface of the seal ring and formed continuously in a circumferential direction
the guide portion of the set ring further has a second annular plate part inserted into the mating ring, and
the second annular plate part is thicker than the first annular plate part.

15. The seal device according to claim 3, wherein
the set ring is provided with a pull portion for pulling the set ring in an axial direction departing from the casing.

16. The seal device according to claim 3, wherein
the mating ring is fastened to the casing by a mechanical fastener, and
the casing, the mating ring, the seal ring, and the set ring are unitized.

17. The seal device according to claim 3, wherein
at least one split line extending in an axial direction are formed at the set ring.

18. The seal device according to claim 4, wherein
the set ring is provided with a pull portion for pulling the set ring in an axial direction departing from the casing.

19. The seal device according to claim 4, wherein
the mating ring is fastened to the casing by a mechanical fastener, and
the casing, the mating ring, the seal ring, and the set ring are unitized.

20. The seal device according to claim 4, wherein
at least one split line extending in an axial direction are formed at the set ring.
